(19) United States
(12) Patent Application Publication
(10) Pub. No.: US 2014/0000923 A1
(43) Pub. Date: Jan. 2, 2014

(54) Portable Power Tool

(71) Applicants: Juergen Dietel, Stuttgart (DE); Andreas Schlegel, Leinfelden-Echterdingen (DE)

(72) Inventors: Juergen Dietel, Stuttgart (DE); Andreas Schlegel, Leinfelden-Echterdingen (DE)

(73) Assignee: Robert Bosch GmbH, Stuttgart (DE)

(21) Appl. No.: 13/994,851

(22) PCT Filed: Dec. 15, 2011
(86) PCT No.: PCT/EP2011/072850

§ 371 Date: Sep. 3, 2013

(30) Foreign Application Priority Data
Dec. 21, 2010 (DE) 10 2010 063 321.5

(51) Int. Cl. B25D 11/06

(52) U.S. Cl. CPC B25D 11/06
USPC 173/47

(57) ABSTRACT

A portable power tool, in particular a rotary and/or demolition hammer, has a pressure lever which is provided to execute a switching operation. A tolerance compensating unit is provided to effect tolerance compensation via a change in position of at least one contact surface.

### PRIOR ART

There are already known hand power tools, in particular hammer drills and/or chipping hammers, having a contact pressure lever provided to execute a switching operation. For the purpose of tolerance compensation, washers of differing thicknesses can be can be inserted between a bearing contact surface of the contact pressure lever and a drive bearing.

### DISCLOSURE OF THE INVENTION

The invention is based on a hand power tool, in particular a hammer drill and/or chipping hammer, having a contact pressure lever provided to execute a switching operation.

It is proposed that the hand power tool have a tolerance compensation unit, which is provided to effect a tolerance compensation through a change in position of at least one bearing contact surface. A “contact pressure lever” is to be understood to mean a lever that transmits a motion from one component to another component, this being, in particular, transversely in relation to a direction of force, such that, during transmission, the contact pressure lever is subjected to bending stress and executes a switching operation. A “switching operation” is to be understood to mean, in particular, an operation in which, as a result of the transmission of a motion, a clutch becomes engaged and/or disengaged, and/or a transmission ratio of a transmission device becomes altered. In particular, a “contact pressure lever” is to be understood to mean a lever that transmits a switching motion of a hammer tube of a percussive mechanism of a hand power tool to a drive bearing of a hammer drill and/or chipping hammer. This motion executes a switching operation of a clutch that is integrated in the drive bearing, which switching operation activates or deactivates the percussive mechanism. Also conceivable, however, are contact pressure levers that are provided for other functions for which there is a need for the motion of one component to be transmitted to another component. A “tolerance compensation unit” is to be understood to mean a unit provided, in particular, to compensate component tolerances resulting from production and/or assembly. A “bearing contact surface” is to be understood to mean an operative surface by which one component transmits forces and/or motions to another component.

This makes it possible, advantageously, to compensate component tolerances resulting from production and/or assembly tolerances, and to set the play of a bearing contact surface of a component in relation to an adjoining component such that perfect functioning is achieved. In particular, it can be achieved that no additional components, such as washers of differing thicknesses, are required for tolerance compensation. It is possible to save on parts, and on assembly time required in order to remove additional components for tolerance compensation and/or to replace them with other components.

Particularly advantageously, the tolerance compensation unit is provided to effect a change in position of at least one bearing contact surface of the contact pressure lever. As a result, advantageously, production and/or assembly tolerances of a hammer tube and/or of a drive bearing and/or of the contact pressure lever can be compensated such that a desired amount of play is set between the bearing contact surface of the contact pressure lever comprising the hammer tube and/or the bearing contact surface of the contact pressure lever comprising the drive bearing, and perfect functioning is achieved. In particular, it is possible to prevent the structure from becoming jammed, in the case of too little play, or to prevent unreliable switching operation in the case of excessive play. Further transmission elements, such as bearings, in particular needle bearings and/or bearing washers, can be disposed between bearing contact surfaces of the contact pressure lever comprising the hammer tube and/or comprising the drive bearing, and the hammer tube and/or the drive bearing itself. The bearing contact surface can thus be decoupled, for example, from a rotary motion.

It is proposed that the contact pressure lever be carried by means of a bearing axle, wherein the tolerance compensation unit has at least one bearing arrangement, which is provided to carry the bearing axle of the contact pressure lever in a plurality of defined positions. A “bearing axle” is to be understood to mean an axle on which the contact pressure lever is rotatably carried. “To carry in a plurality of defined positions” is to be understood to mean that the bearing arrangement is provided to carry the bearing axle at differing positions, for example that the bearing axle can be displaced and/or rotated within a region provided for this purpose, and that a selected position can be fixed by non-positive or positive connection. For example, the bearing unit can have a clamping device, which is provided to define a position by non-positive connection, and/or a latching device, in which a latching element fixes a position by latching-in. In particular, the bearing unit can have one or more receiving regions, which are designed such that the position of the bearing axle can be fixed by repositioning.

As a result, the position of a bearing contact surface of the contact pressure lever can be fixed by a change in the position of the bearing axle of the contact pressure lever. The tolerance compensation unit, set thus, can reliably retain this setting, and unwanted misadjustment can be prevented.

Particularly advantageously, the bearing arrangement is realized so as to be at least partially integral with a hand power tool casing. “Integral with” is to be understood here to mean, in particular, connected in a materially bonded manner such as, for example, by a welding process and/or an adhesive bonding process and/or, particularly advantageously, by being formed-on, such as, for example, by being produced from a casting and/or by being produced in a single- or multi-component injection process. The bearing arrangement can have a pin-type stud, and the bearing axle, which is provided with a recess, can be placed on to the stud. In particular, the bearing arrangement can have a receiving region, which is realized as a recess and into which one end of the bearing axle can be inserted. As a result, the bearing arrangement can be fastened to the casing of the hand power tool in a particularly reliable manner. Production can be effected in an inexpensive manner, and savings of components and assembly costs can be achieved.

In a further design of the invention, it is proposed that the bearing axle be rotatably carried. “Rotatably carried” is to be understood to mean, in particular, that the bearing unit includes a rotatably carried receiving region that receives the bearing axle, or that the bearing axle is rotatably carried in a receiving region. This makes it possible, advantageously, to realize a setting movement of the bearing axle that is suitable for effecting a change in the position of a bearing contact surface of the contact pressure lever.

Further, it is proposed that the tolerance compensation unit have an eccentric. An “eccentric” is to be understood to mean, in particular, a contour of a component, the axis of symmetry of which is offset relative to a symmetry of a main contour and/or of a rotation axis of this component. This makes it possible, advantageously, for a change in the position of a bearing contact surface of the contact pressure lever to be effected as a result of rotation of a component of the tolerance compensation unit.

Particularly advantageously, the bearing axle comprises the eccentric. In particular, the bearing axle has an eccentric at at least one end, preferably at both ends. As a result, a rotation of the bearing axle in the bearing arrangement can effect a change in position of the bearing contact surface of the contact pressure lever. A simple, inexpensive tolerance compensation unit can be produced.

Further, it is proposed that the bearing axle have a cylindrical middle part and at least one end having a contour secured against rotation. A “contour secured against rotation” is to be understood to mean a contour that, by positive connection, prevents a rotary motion. In particular, the contour can be realized as polygon. For example, the contour can be realized as a triangle, a hexagon, but preferably as a quadrangle. The contour can be realized as a socket of a recess and placed on to a receiving region of the bearing arrangement that is realized as an external contour but, in particular, the contour is realized as an external contour, and the bearing arrangement has, as a receiving region, a receiving region having a matched internal contour. The cylindrical middle part enables the contact pressure lever to be carried in a movable manner, which is advantageous. The contour secured against rotation makes it possible to ensure, advantageously, that the bearing axle does not effect any unwanted changes of position. The bearing unit can be realized such that the bearing unit includes a rotatably carried receiving region, in particular an eccentrically rotatably carried receiving region, and the change in position is effected by rotation of the receiving region. Preferably, the bearing unit is realized such that the receiving region is fixedly attached and the bearing axle is moved by being repositioned to a next position. For example, a quadrangular contour gives four possible positions, and a hexagonal contour gives six possible positions. Corresponding to each position is another change in position, defined by the eccentric, of at least one bearing contact surface of the contact pressure lever.

In a further design of the invention, it is proposed that the tolerance compensation unit have a fixing unit, which is provided to fix a movably carried setting means of the tolerance compensation unit in differing positions. A “fixing unit” is to be understood to mean a unit provided to fix a position by positive and/or non-positive connection, for example by means of a clamping device and/or by means of a latching device, in which a latching element fixes a position by latching-in. It can thereby be achieved, advantageously, that the tolerance compensation unit does not execute any unwanted changes in position. The fixing unit can thus be configured such that it can be released by an operator. This makes it possible, advantageously, for the tolerance compensation unit to be easily adjusted in order to effect a new tolerance setting.

Advantageously, the hand power tool casing has at least one service aperture, which is provided for setting the tolerance compensation unit from the outside. A “service aperture” is to be understood to mean a region of the hand power tool casing that can be easily opened by the operator, for example a covering cap. By opening the service aperture, the operator can access a setting element of the tolerance compensation unit, and can execute a setting operation. This enables the operator to effect a new tolerance setting if required. As a result, the service life of the hand power tool can be advantageously increased, and servicing can be performed easily. It is also possible for a plurality of service apertures to be provided, in particular two service apertures. The service apertures are advantageously provided in the case of each bearing arrangement of the tolerance compensation unit, such that each bearing arrangement can be set by an operator. The bearing axle in this case can be received in the bearing arrangement by means of ends having a contour that can be turned. This makes it possible, advantageously, for the bearing arrangements to be adjusted individually. The tolerance compensation unit can also be configured such that the contact pressure lever is received directly by the bearing arrangements. It is possible to dispense with a bearing axle, and to save on additional components.

### DRAWING

Further advantages are disclosed by the following description of the drawing. The drawing shows an exemplary embodiment of the invention. The drawing, the description and the claims contain numerous features in combination. Persons skilled in the art will also expediently consider the features individually and combine them to form appropriate further combinations.

In the drawing:

FIG. 1 shows a schematic representation of a hand power tool with a tolerance compensation unit according to the invention,

FIG. 2 shows a detail of a schematic representation of a hand power tool with a tolerance compensation unit according to the invention,

FIG. 3 shows a schematic representation of a detail of a bearing arrangement of a tolerance compensation unit according to the invention,

FIG. 4 shows a schematic representation of a detail of the bearing arrangement with a bearing axle of the tolerance compensation unit according to the invention,

FIG. 5 shows a schematic representation of the bearing axle,

FIG. 6 shows a schematic representation of an eccentric of the bearing axle,

FIG. 7 shows a detail of a schematic representation of the hand power tool with a tolerance compensation unit according to the invention, in a second exemplary embodiment, and

FIG. 8 shows a schematic representation of a bearing axle in a second exemplary embodiment.

### DESCRIPTION OF THE EXEMPLARY EMBODIMENT

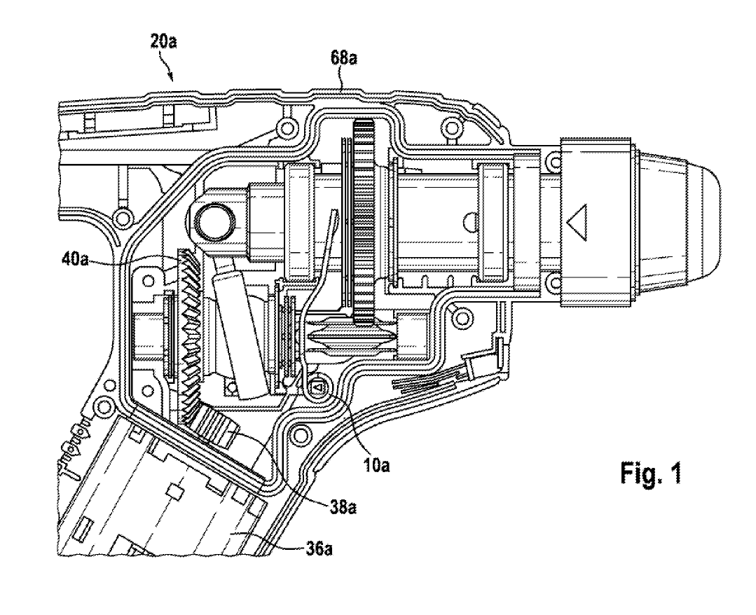

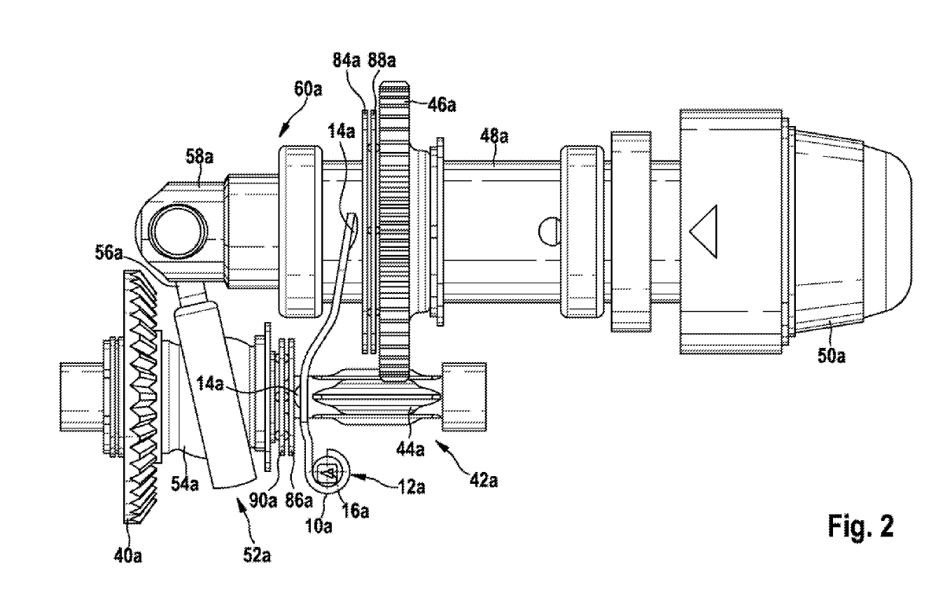

FIG. 1 and FIG. 2 show a hand power tool, which is realized as a hammer drill, having a contact pressure lever 10a, which is provided to execute a switching operation, and having a tolerance compensation unit 12a, which is provided to effect a tolerance compensation through a change in position of a bearing contact surface 14a. The hand power tool has a hand power tool casing 20a, which comprises two casing shells 68a. During operation, an electric motor 36a drives a bevel gear 40a via a pinion 38a. Via an intermediate shaft 42a, the bevel gear 40a drives a pinion 44a, which drives a hammer tube 48a via a toothed wheel 46a. However, it is also possible for a different transmission device, familiar to persons skilled in the art, to be provided for the purpose of transmitting the rotary motion from the motor 36a to the intermediate shaft 42a. Via the hammer tube 48a, a drill chuck 50a is made to rotate. In order to switch on a percussive operating mode, the hammer tube 48a is displaced in the direction of the bevel gear 40a by the pressure exerted in the case of a drilling operation. As a result, a force is exerted upon a drive bearing 52a via the contact pressure lever 10a. A clutch, not represented, inside the drive bearing 52a establishes a flow of force between the bevel gear 40a and a bearing sleeve 54a, such that a nutating finger 56a acts upon a piston 58a of percussive mechanism 60a and drives the latter back and forth. If the drill chuck 50a is relieved of load again, at the end of the drilling operation, the hammer tube 48a moves in the opposite direction, away from the bevel gear 40a, such that the drive bearing 52a is again relieved of load, the clutch, not represented, in the drive bearing 52a interrupts the flow of force between the bevel gear 40a and the bearing sleeve 54a, and the percussive operating mode is switched off. In order to decouple the two bearing contact surfaces 14a of the contact pressure lever 10a from the rotary motion of the hammer tube 48a and of the drive bearing 52a, a needle bearing 88a and a bearing washer 84a are disposed between the contact pressure lever 10a and the hammer tube 48a, and a needle bearing 90a and a bearing washer 86a are disposed between the contact pressure lever 10a and the drive bearing 52a.

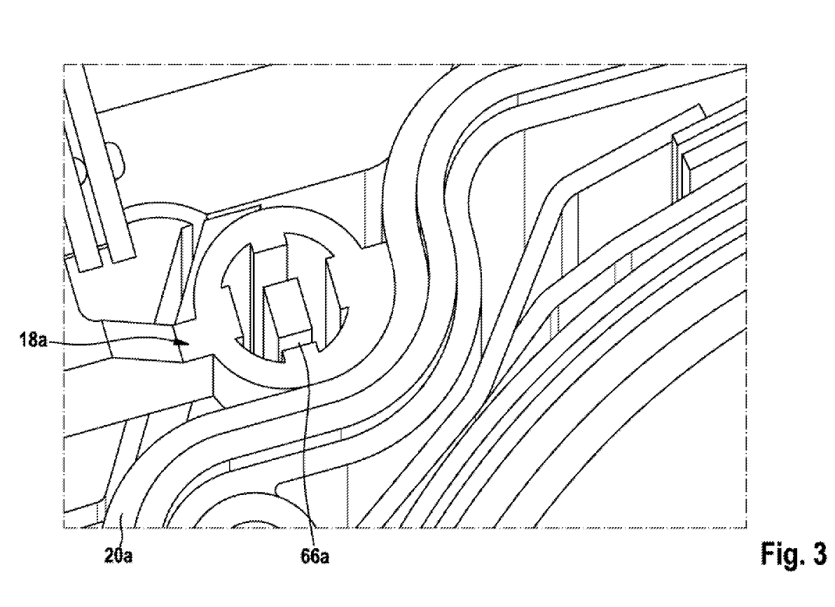

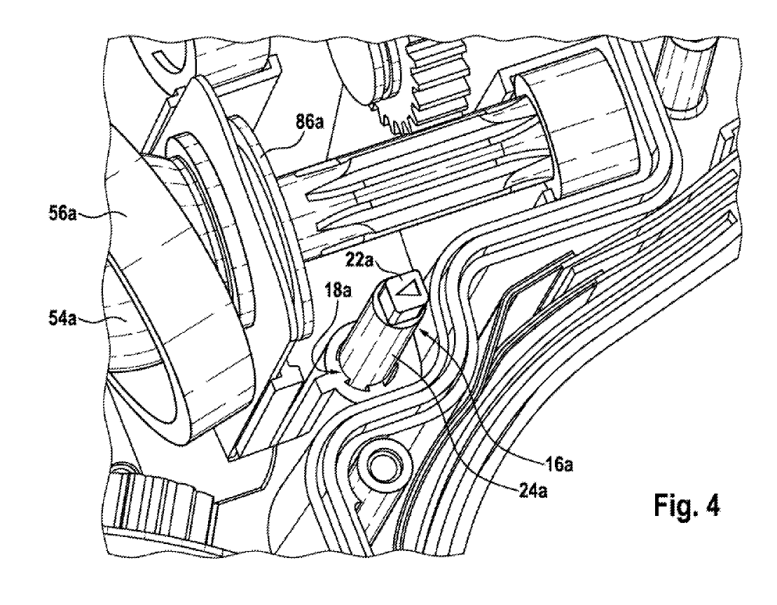

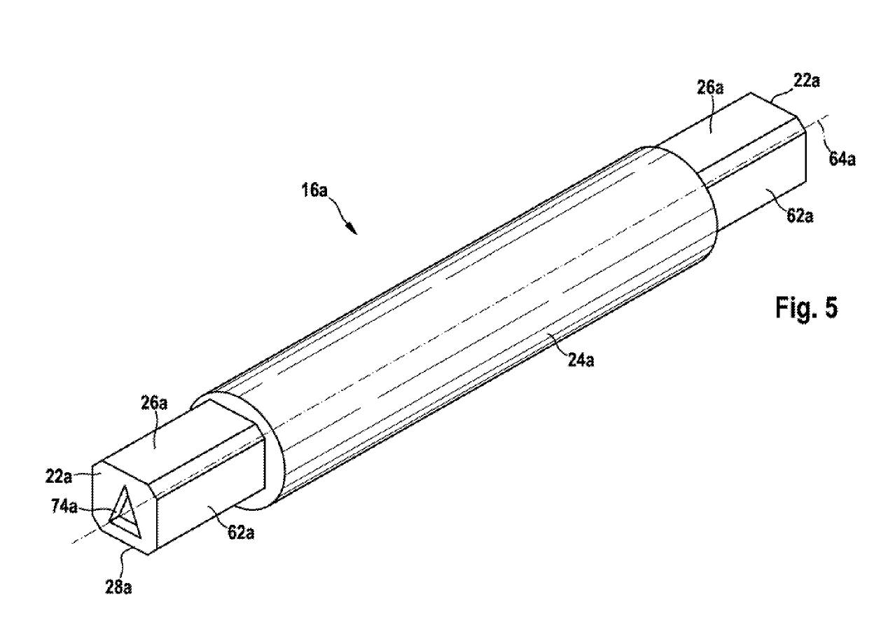

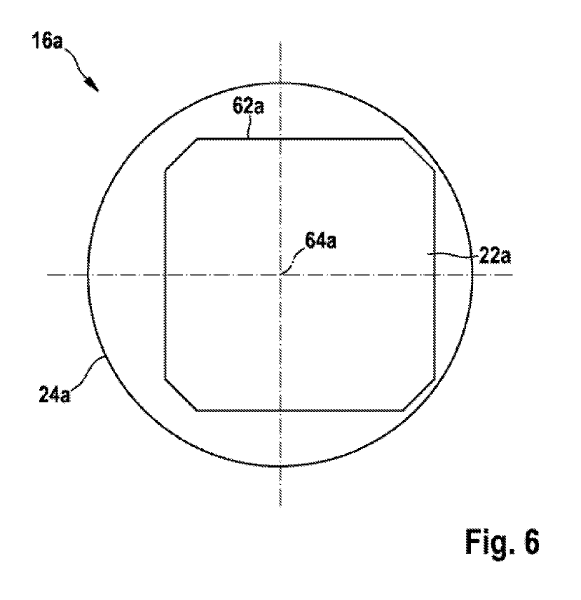

The tolerance compensation unit 12a is provided to effect a change of position of one of the bearing contact surfaces 14a of the contact pressure lever 10a. For this purpose, the contact pressure lever 10a is carried by means of a bearing axle 16a. The tolerance compensation unit 12a has a bearing arrangement 18a, which is provided to carry the bearing axle 16a of the contact pressure lever 10a in a plurality of defined positions. The bearing arrangement 18a (FIGS. 3, 4 and 5) is realized so as to be integral with the hand power tool casing 20a. The tolerance compensation unit 12a has an eccentric 22a. The bearing axle 16a in this case comprises the eccentric 22a. The bearing axle 16a has a cylindrical middle part 24a and two ends 26a that have a contour 28a secured against rotation. The cylindrical middle part 24a serves to carry the contact pressure lever 10a in a movable manner. The two ends 26a are realized as an external square 62a, which, as an eccentric 22a, is disposed eccentrically in relation to a central axis 64a of the bearing axle 16a (FIG. 6). The bearing arrangement 18a has recesses, in the form of an internal square 66a, in the casing shells 68a of the hand power tool casing 20a. The external square 62a of the bearing axle 16a can be inserted, in four differing positions, in the internal square 66a of the bearing arrangement 18a. Owing to the eccentric 22a, each of these positions corresponds to a different position of the bearing contact surfaces 14a. In the exemplary embodiment, the central axis 64a is displaced by −0.3, −0.1, 0.1 and 0.3 mm. When the contact pressure lever 10a is being mounted, the bearing axle 16a is first, in a middle position, inserted in the bearing arrangement 18a, and the play between the bearing contact surfaces 14a, the drive bearing 52a and the hammer tube 48a is then determined. A marking 74a in the form of a triangle indicates the orientation of the bearing axle 16a. Alternatively, a dot, line, notch or chamfered surface, for example, can also be applied as a marking 74a to the bearing axle 16a. The play can be increased or reduced in that the bearing axle 16a is then inserted with a 90° or 180° forward or backward turn in each case. The eccentrics 22a are attached with the same offset at both ends 26a, such that the bearing axle 16a can be inserted on both sides. If a greater tolerance compensation is required, then the bearing axle 16a can also be exchanged for a different bearing axle, having a different set of eccentrics. The bearing axle 16a can be repositioned without the need to demount further components. In particular, removal of the intermediate shaft 42a can be avoided.

The following description and the drawing of a further exemplary embodiment are limited substantially to the differences between the exemplary embodiments, and, in principle, reference may also be made to the drawings and/or the description of the other exemplary embodiment in respect of components designated in the same manner, in particular in respect of components denoted by the same reference numerals. In order to differentiate the exemplary embodiments, the letter b has been appended to the reference numerals of the second exemplary embodiment, instead of the letter a of the first exemplary embodiment.

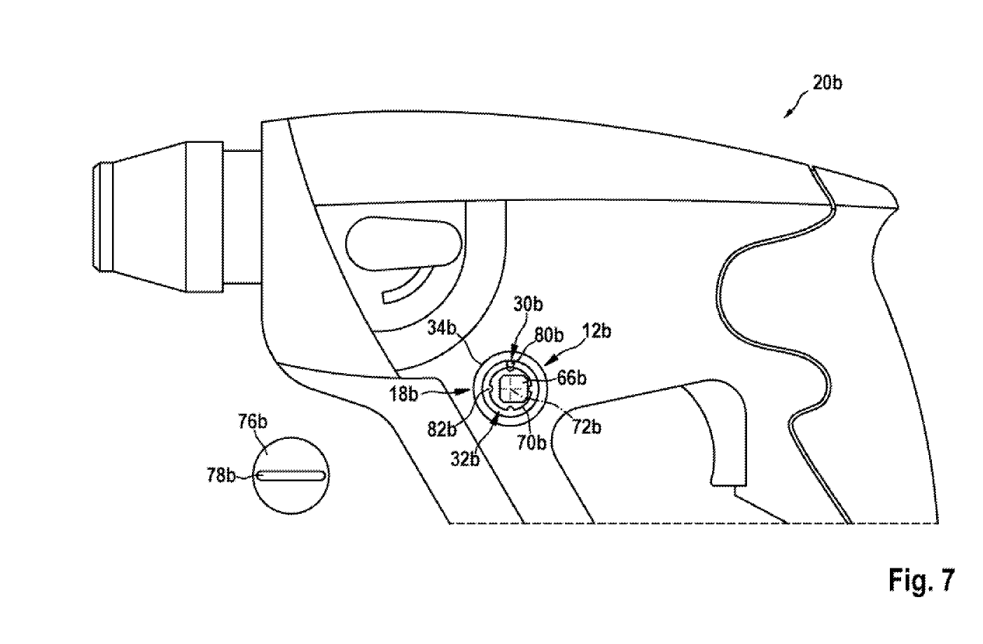

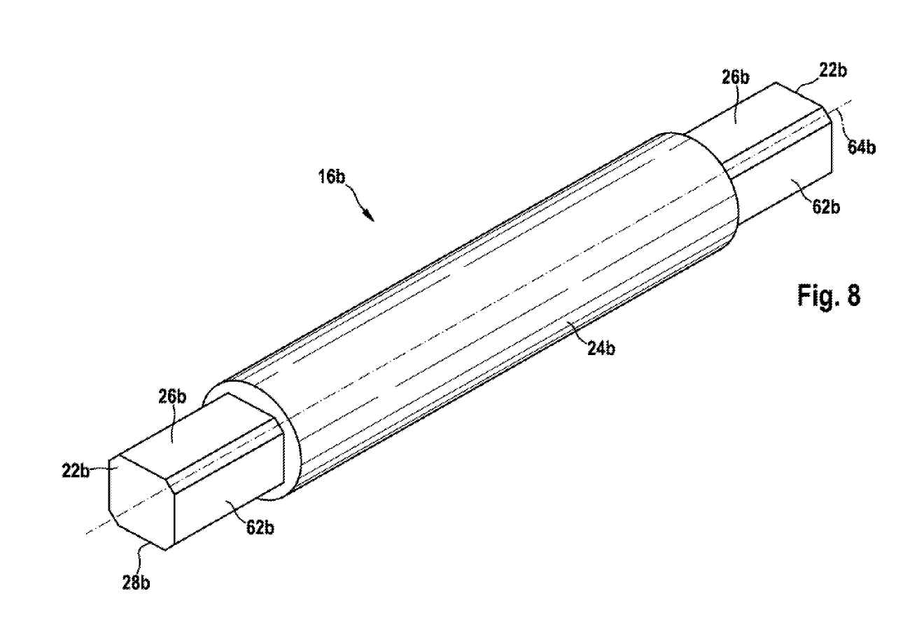

The exemplary embodiment represented in FIG. 7 and FIG. 8, having a tolerance compensation unit 12b, differs from the first exemplary embodiment in that, in particular, a bearing axle 16b is rotatably carried. For this purpose, a bearing arrangement 18b, as a setting means 32b, has a bearing bush 70b, in which there is realized an internal square 66b, which receives an external square 62b of the bearing axle 16b. The bearing bush 70b can be rotated in the bearing arrangement 18b. The internal square 66b is disposed eccentrically relative to a rotation axis 72b of the bearing bush 70b. Two ends 26b of the bearing axle 16b are realized as an external square 62b, which is disposed centrally in relation to a central axis 64b of the bearing axle 16b (FIG. 8). A position of a cylindrical middle part 24b of the bearing axle 16b can be changed as a result of rotation of the bearing bush 70b, and a change in position of one of the bearing contact surfaces 14b can be achieved. The tolerance compensation unit 12b has a fixing unit 30b, which is provided to fix the movably carried setting means 32b of the tolerance compensation unit 12b in differing positions. The fixing unit 30b is realized as a latching unit, having a latching ball 80b that is pressed into latching recesses 82b of the bearing bush 70b by a spring, not represented. The latching unit is realized such that the bearing bush 70b latches-in, when a rotation is effected, to four positions. The latching unit can also be realized such that the fixing unit latches-in, for example, to six, eight or another number of positions.

A hand power tool casing 20b has a service aperture 34b, having a removable cover 76b provided for setting the tolerance compensation unit 12b from the outside. The cover 76b has a slit 78b, by means of which the cover can be screwed off by an operator. In order to set the tolerance compensation unit 12b, the operator rotates the bearing bush 70b to a next latching position of the latching unit until a desired tolerance compensation is achieved. The internal square 66b is of such a length that a tool having an external square can be used to adjust the bearing bush 70b.

1. A hand power tool comprising:
a contact pressure lever configured to execute a switching operation; and
a tolerance compensation unit configured to effect a tolerance compensation through a change in position of at least one bearing contact surface.

2. The hand power tool as claimed in claim 1, wherein:
the contact pressure lever includes the at least one bearing contact surface, and
the tolerance compensation unit is configured to effect the change in position of the at least one bearing contact surface of the contact pressure lever.

3. The hand power tool as claimed in claim 2, further comprising:
at least one bearing axle that supports the contact pressure lever,
wherein the tolerance compensation unit includes at least one bearing arrangement configured to support the at least one bearing axle in a plurality of defined positions.

4. The hand power tool as claimed in claim 3, further comprising:
a hand power tool casing,
wherein the at least one bearing arrangement is at least partially integral with the hand power tool casing.

5. The hand power tool as claimed in claim 3, wherein the at least one bearing axle is supported rotatably.

6. The hand power tool as claimed in claim 1, wherein the tolerance compensation unit includes an eccentric.

7. The hand power tool as claimed in claim 3, wherein the at least one bearing axle includes an eccentric.

8. The hand power tool as claimed in claim 7, wherein:
the at least one bearing axle includes a cylindrical middle part, a first end, and a second end, and
at least one of the first end and the second end includes a contour secured against rotation.

9. The hand power tool as claimed in claim 1, wherein:
the tolerance compensation unit has a fixing unit and a movably carried setting mechanism, and
the fixing unit is configured to fix a the movably carried setting mechanism in differing positions.

10. The hand power tool as claimed in claim 1, further comprising:
a hand power tool casing having at least one service aperture configured for setting the tolerance compensation unit from an outside of the hand power tool.

11. The hand power tool as claimed in claim 1, wherein the hand power tool is a hammer drill.

12. The hand power tool as claimed in claim 1, wherein the hand power tool is a chipping hammer.
